(19) United States
(12) Patent Application Publication
(10) Pub. No.: US 2006/0219263 A1
(43) Pub. Date: Oct. 5, 2006

(54) System and method for cleaning, disinfection, sterilization, and decontamination

(76) Inventors: Max Friedheim, San Diego, CA (US); Stephen Michael Lord, Encinitas, CA (US)

Correspondence Address: Joseph R. Evanns;Evanns & Walsh, 119 N. San Vicente Blvd. #206, Beverly Hills, CA, 90211, US

(21) Appl. No.: 11/335,842

(22) Filed: Jan. 18, 2006

Related U.S. Application Data
(60) Provisional application No. 60/644,904, filed on Jan. 18, 2005.

(51) Int. Cl. B08B 7/00; B08B 3/00

(52) U.S. Cl. 134/19; 134/105

(57) ABSTRACT

A system and method for cleansing, including cleaning, disinfection, sterilization and decontamination comprises apparatus for generating and issuing superheated vapor including at least one (1) sterilant, the liquid from which the superheated vapor is generated comprising solution of sterilant and in some applications at least one anticorrosive and includes control for exposure to said superheated vapor. A method for cleaning, disinfecting, sterilizing, and decontaminating includes the steps of directing superheated vapor under pressure including at least one sterilant therein toward the object to be cleaned, disinfected, sterilized and decontaminated and may include provision of an anticorrosion reagent therein. Apparatus may provide a tortuous path such as to expose an object to be cleaned, sterilized, disinfected, or decontaminated in various aspects such as to treat substantially the entire object, either through use of manual intervention or substantially wholly automated. A method employing such apparatus is provided.

THIS IS A NON-PROVISIONAL PATENT APPLICATION CLAIMING THE FILING DATE OF JAN. 18, 2005 OF PROVISIONAL PATENT APPLICATION SER. NO. 60/644,904.

### BACKGROUND OF THE INVENTION

1. Field of the Invention

The invention relates and pertains to systems and methods for accomplishing cleaning, disinfection, sterilization, and decontamination.

2. Description of the Prior Art

As used herein, the term “cleaning” means and refers to removal of what is normally referred to as “dirt” or “soiling,” i.e., visible foreign matter such as dust, grime, dried blood, dirt and the like from objects which are required to be free of same.

The term “disinfection” means and refers to removal and killing of organisms with varying amounts of resistance less than that of spores or protozoan cysts.

“Sterilization” means and refers to removing and killing spores such as bacillus subtilis.

“Decontamination” means and refers to the removal and/or disabling of toxic materials such as chemicals (including those used in chemical warfare), radiation, and the like.

“Sterilant” means and refers to a sterilizing agent, and is occasionally specifically employed herein to refer to fluid used in sterilization to contact spores and remove or kill same.

Existing systems and methods for accomplishing cleaning, disinfection, sterilization, and/or decontamination are applicable to some but not all of the foregoing activities and have, within such constraints, varying degrees of effectiveness, scope, convenience and expeditiousness.

Applications include medical, commercial, industrial and military among others, including weapons of mass destruction and span the range from microscopic to vehicles to buildings and further include human beings as well as objects.

Existing methods and apparatus applying oxidants and peroxidants for the above stated purposes are required to employ relatively high concentration of oxidants and peroxidants—as high as 35% or more of hydrogen peroxide, a powerful and commonly-used peroxidant—in order to accomplish the purpose. The corrosiveness of H₂O₂ in relatively high concentrations causes destruction and/or deterioration of particular materials to which they are applied as, for example, electronics, avionics, steel, requiring the peroxide solution and residue to be flushed away. For small and/or hard-to-access mechanisms such as typewriters, computers, certain types of weapons, avionics, electronics, and the like, such flushing is not wholly effective and as a result such mechanisms must be eventually discarded due to corrosion.

Particular examples include devices depicted and described in U.S. Pat. No. 4,414,037 (Friedheim); U.S. Pat. No. 4,282,903 (Powell); U.S. Pat. No. 5,290,511 (Newman); U.S. Pat. No. 4,263,258 (Kalasek); U.S. Pat. No. 4,169,123 (Moore); U.S. Pat. No. 5,580,530 (Kowatsch); U.S. Pat. No. 6,036,918 (Kowanko); U.S. Pat. No. 5,508,009 (Rickloff); U.S. Pat. No. 5,344,622 (Faddis); U.S. Pat. No. 4,909,999 (Cummings); U.S. Pat. No. 4,282,179 (Gunther).

The foregoing existing apparatus and methods exhibit shortfalls and deficiencies including bulkiness, unsuitability for expeditious use and for reaching difficult-to-access portions of objects to be cleaned, disinfected, sterilized and decontaminated generally requiring an autoclave or cleaning chamber. In U.S. Pat. No. 4,414,037, a number of these problems are addressed; however, sterilization is not readily accomplished, nor is decontamination.

Consequently, there has been a felt and unfulfilled need for a general system and method for expeditious and convenient cleaning, disinfecting, sterilizing, and decontaminating for the generality of objects, including those which may be difficult to access, corrodible, small, or fragile, and may include human beings and other living things.

### SUMMARY OF THE INVENTION

A system and method for cleaning, disinfection, sterilization, and decontamination includes means for generating and emanating superheated vapor including at least one sterilant. In particular embodiments, an anti-corrosion agent is also employed. The liquid from which the superheated vapor is generated comprises solution of sterilant, as well as anti-corrosion means in particular embodiments.

A method for cleaning, disinfecting, sterilizing, and decontaminating includes the steps of generating superheated vapor under pressure, providing at least one sterilant therein, and directing the superheated vapor under pressure toward the object to be cleaned, disinfected, sterilized, and decontaminated and may include the step of providing an anti-corrosion reagent in connection with said superheated vapor.

A method for cleaning, disinfecting, sterilizing, and decontaminating may be employed in accordance with the invention including the steps of directing superheated vapor containing a steriliant toward an object in such a manner as to subject substantially all of the object to the vapor flow, such step involving in a particular embodiment, providing a tortuous path as, for example, a serpentine path upon or adjacent to the object. Said system and method provide for selectively varying and adjusting the concentration of sterilant, the temperature of the superheated vapor at its source, the distance of the source of superheated vapor from the object, the temperature of the superheated vapor at the object, the pressure of the superheated vapor stream to achieve the desired result, among other parameters.

### BRIEF DESCRIPTION OF THE DRAWINGS

FIG. 1. depicts a system for cleaning, disinfecting, sterilizing and decontamination, in accordance with the invention;

FIG. 2. is a section through the line 2-2 of FIG. 1;

FIG. 3. depicts in fragmentary form a portion of an object to be cleaned showing a path thereon of superheated vapor applied thereto in accordance with the invention.

FIG. 4. is a depiction, somewhat simplified and schematic, of a lumen in an enclosure or needle;

FIG. 5 is a schematic diagram relating to a particular mode of operation in accordance with the invention;

FIG. 6 is a schematic diagram of operation in accordance with the invention in conjunction with a conveyor;

FIG. 7 is a view, somewhat schematic, of a superheated vapor generator multi-unit system employed in accordance with the invention; and

FIG. 8 is a schematic diagram of a control of the superheated vapor generator system of FIG. 7.

### DETAILED DESCRIPTION OF THE INVENTION

U.S. Pat. No. 4,034,037 (the '037 patent) and U.S. Pat. No. 5,471,556 (the '556 patent), U.S. Pat. No. 6,006,009 (the '009 patent), all issued to an inventor herein, Max Friedheim, are incorporated by reference herein and as appropriate the disclosures thereof will be employed in connection with the description and discussion herein of corresponding parts.

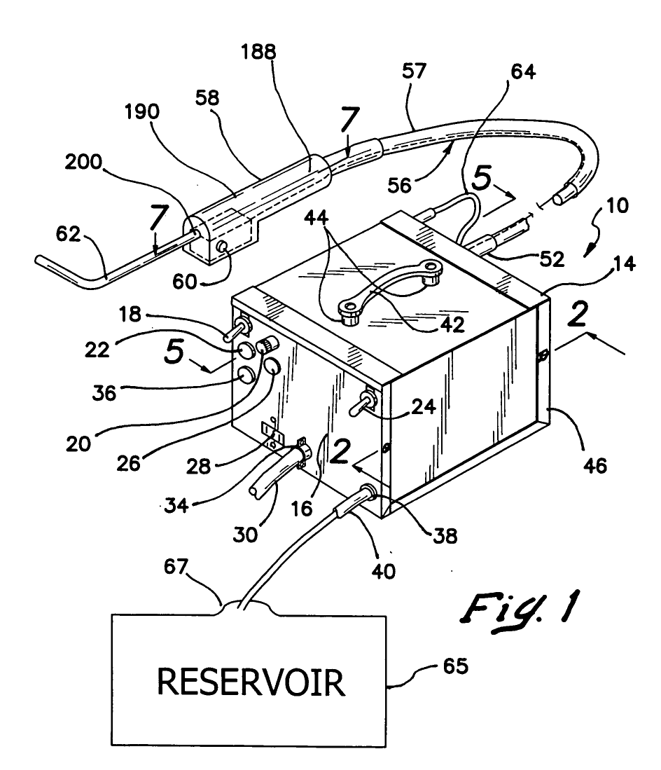

As depicted in FIG. 1, a system 10 for accomplishing cleaning, disinfection, sterilization, and decontamination in accordance with the invention comprises a base forming the bottom of housing 14, which together with base 12 forms a container for a portion of system 10. The top and sides of housing 14 are fastened to base 12 by conventional means such as screws and are removable to permit access to the interior of system 10

Controls of the system 10 are disposed upon a portion of housing 14 comprising a control panel 16. A power switch 18 is conveniently disposed on panel 16 and comprises a bi-polar arrangement of conventional type, controlling drawing of power from an external source i.e. whether the system 10 is “On” or “Off” as is more fully described hereinbelow. Said control is in accordance with circuitry and electronics disclosed in detail in the '009 patent.

Disposed upon control panel 16 adjoining power switch 18 is a removable line fuse holder 20. A white power light 22 is disposed on control panel 16 and as described in more detail hereinbelow functions to indicate power in the system 10.

Also disposed on the control panel 16 is a manual vapor heating switch 24 which participates in controlling the generation of superheated vapor as described herein. An amber vapor generator light 26 is disposed on the control panel 16 adjacent power indicator 22. Light 26 as described hereinbelow is an indicator of the operation of electronic controls of a vapor generator (described in more detail below and in the '009 patent) in the system 10.

A footswitch electric receptacle 28 is disposed in a lower part of panel 16 and accommodates a foot switch (not shown) for controlling superheated vapor production.

A power line 30 is accommodated in a fitting 32 attached to the panel 16 around a slot 34 for passage therethrough of power line 30.

An amber heating chamber light 36 is positioned on panel 16 adjacent power light 22 and is electrically connected as described hereinbelow to remain on while a heating element described below is drawing current. A liquid pick-up tube inlet 38 is defined in control panel 13 to receive a liquid pick-up tube 40.

At the top of housing 14 is disposed a carrying handle 42 secured by fasteners 44 to housing 14. In a rear panel 46 of housing 14, an aperture 48 is defined; secured on both sides of aperture 48 is a gasket-type fitting 50. Aperture 48 and gasket 50 accommodate and receive a vapor exit pipe connector 52. A quick disconnect connector member 54 is disposed at an outer end of pipe 52 and connectable to a vapor control member or wand 56. The wand 56 contains a grip handle 58 in which is disposed a vapor control switch operable by a vapor control push button 60. A tube 62 extends outwardly from the control member handle 58. A vapor control power connector 64 connects between the vapor control 60 and into a socket 64 and is mounted in rear panel 46.

Pick-up tube 40 is depicted as connected to a reservoir 65 through a port 67. Reservoir 65 is depicted in simplified, schematic form only and may be of appropriate shape and size among other parameters, in particular applications of the invention.

Contained in reservoir 65 is liquid for input into system 10 for vaporization into superheated vapor. The nature and function of said liquid is discussed more fully hereinbelow.

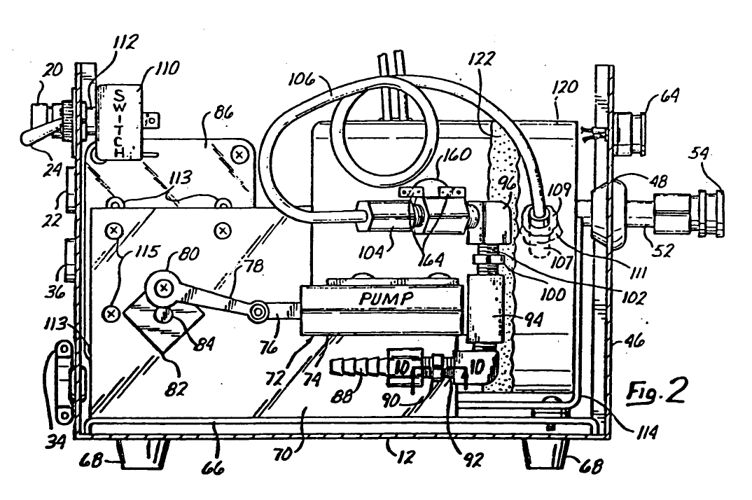

Turning now to FIG. 2, a support plate 66 is fastened to base 12, which in turn rests upon feet 68.

A mounting plate 70 is fastened to support 66. Fastened to mounting plate 70 is a pump 72. Pump 72 includes a cylinder 74 receiving a piston 76 which reciprocates within cylinder 74. Piston 74 is pivotably and connected to a rod 78 with a pivoting member 80 at the opposite end of the rod from the pivotable connection between the rod 78 and the piston 76. A substantially square cam 82 is pivotably attached to pivot member 80 and pivots and is rotatable on a shaft 84 mounted and pivotably journalled in plate 70. In particular applications, cam 82 is at least ⅞ inch square. This configuration of the cam 82 has been found to add leverage beyond that achieved by the device in the '037 patent and to eliminate possible vapor-lock in the fluid line as fluid enters the vaporization chamber, in addition to providing more efficient prevention of back pressure of steam build-up within the vaporization chamber. This is of moment in system 10 due to the substantial heat generated in a smaller area than in the device of the '037 patent.

An electric motor 86 is mounted upon mounting plate 70 and rotates shaft 84. Electric motor 86 is Class B wired to withstand heat generated in system 10. Cam 82 is rotated by shaft 84, which in turn rotates on a sleeve in pivot member 80. An inlet fitting 88 accommodates inflow of liquid from inlet port 38 through inlet conduit 40. A first check valve 90 is connected to inlet fitting 88 and is shown in detail in FIG. 2. Check valve 90 not only blocks backflow and prevents intake of solids into the apparatus but also affects by particular parameters the liquid content of superheated vapor produced by system 10.

An elbow fitting 92 is connected to check valve 90 and accommodates flow of liquid therethrough to a T-fitting 94. T-fitting 94 is connected to the fluid intake inlet 88. Connected to T-fitting 94 is a second check valve 100 which in turn is connected to an elbow fitting 96. Check valve 100, is identical to and is described in detail hereinbelow in conjunction with the description of check valve 90.

From fitting 96 fluid passes through a fitting 104 which is connectable to a tube 106, depicted as coiled for economy of space utilization. Tube 106 leads into a superheated vapor generator 120. A sleeve 107 is secured to tube 106 at its point of entry into generator 120. Sleeve 107 is preferably composed of aluminum and is welded to tube 106. Sleeve 107 preferably extends substantially ¾″ above the top surface of generator 120 and is secured to generator 120 at an exterior weld 109 and an interior weld 111.

A male connector 110 is fastened to screw 112 mounted in panel 16 and connected to vapor switch 24. A bracket 114 fastened to plate 12 provides support and mounting for the vapor generator 108.

Electric gear motor 86 is secured by fasteners 115 to mounting bracket 70. Electric gear motor 86 is of conventional type and in a preferred embodiment provides 366 RPM at 115 volts. Motor 86 drives pump 72 by means of cam 82 joumalled on shaft 84 which in turn is driven by motor 86. A pair of buffer members 113 upon motor 106 are in contact with bracket 70 for the purpose of minimizing the effect of vibration upon the structure.

Vapor generator 120 comprises metal castings in two parts welded together at 122 defining a vaporization chamber (not shown) 6. Generator 120 is detachably positioned within housing 14 and is secured thereto at bracket 114 as noted hereinabove, and rests on washers 124 between plate 66 and bracket 114. A vaporization chamber 126 is defined centrally within generator 120. The bottom section is longer to allow room for a heating element 132 described below. As depicted, chamber 126 is substantially spherical; however, other configurations may be employed in accordance with the invention. In the depicted spherical configuration, the periphery of chamber 126 is referred to on occasion as a wall. In other configurations in accordance with the invention such periphery may comprise more than one wall.

A more fully described and discussed in the '037 and '556 patent, walls of chamber 126 may be of varied surfaces (etched as in the '037 patent; cut in ridges and grooves as in the '556 patent), among other configurations.

As disclosed in full detail in the '556 patent, disposed in generator 120 is a heating element for heating to the desired temperature for generating superheated vapor. Control of temperature and heat generation as well as the frequency and duration of flows of superheated vapor in system 10 is as described in the '009 patent, through a system of electronics and controls whose purpose is to achieve selected operating temperatures, to prevent overheating and to provide a desired level frequency and duration of flows of superheated vapor.

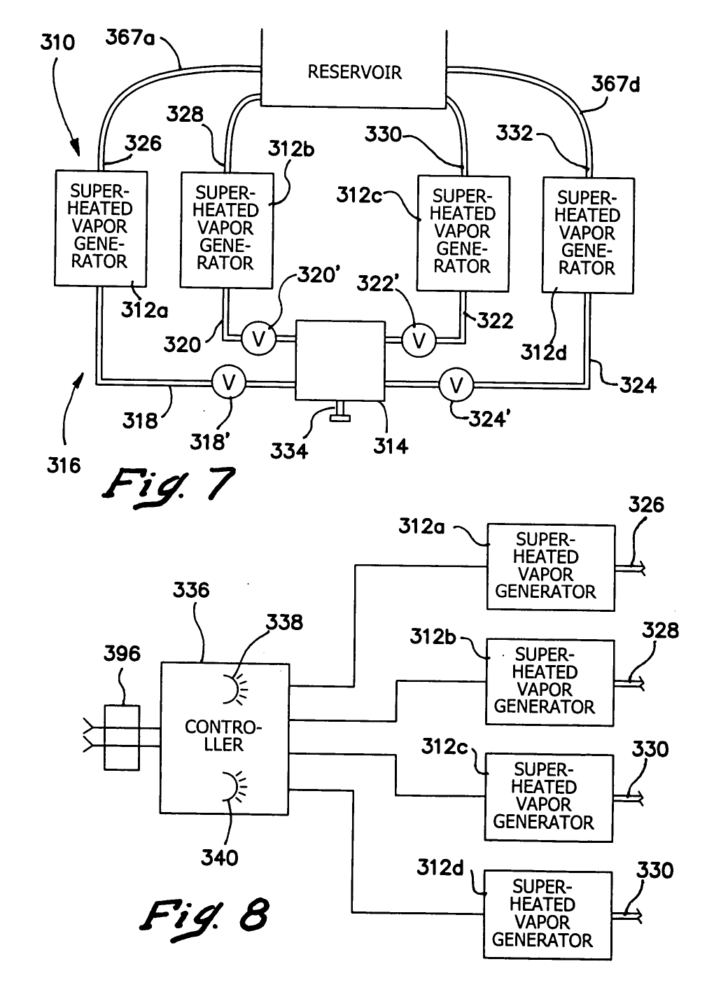

As described in fuller detail in the '009 patent and as shown and depicted in FIG. 7, 8, a plurality of superheated vapor generators 10a-10d are controlled by a logic box 122 of conventional type including circuitry regulating input of liquid and heating of generators 120.

Vapor control member or wand 56 in detail is as described and depicted I the '556 patent. Wand 56 comprises a conduit member 57, a handle member 58, and a tube 62 as previously discussed.

Handle 58 includes a central bore 188. An insulator sheath 190 is disposed around handle 58. Insulation sheath 190 may comprise rubber or other conventional material.

Switch 60 controls the operation of wand 56. Switch 60 is of conventional type, for example a single-pole spring-operated mechanism. Conduit member 57 is fastened to tube 62 by fitting (not shown). Tube 62 is received in an aperture 200 at the outer end of handle 58 and may be fabricated of brass or other durable non-corrosible material.

The electrical circuitry for system 10 is as described and depicted in the '556 patent and the '009 patent. Power switch 18 controls the on/off condition of the entire system. Switch 24 is a manual vapor generator switch which as noted above is mounted on control panel 16. A switch (not shown) in wand 56 is actuated by push button 60 and like switch 24 controls vapor generation but is contained in the wand 56 for ease of operation of the device, these switches controlling the on/off condition of pump motor 72.

Red light 26 is connected to the system thermostats in order to notify the operator of a change in condition in the system, as described in the '556 patent.

As more fully described in the '556 patent, white light 22 is illuminated when power switch 18 is closed (i.e. when the power switch is turned on). Amber light 36 is on when heating element in generator 120 is drawing current and remains on so long as the heating element draws current. When light 36 goes out, this indicates that generator 120 has reached its operating temperature.

System 10 is connected by hose 40 to liquid reservoir 65. The liquid contained in reservoir 65 may be any of a broad range related to the purposes for which system 10 is to be used. In a typical cleaning context in which the system is employed to loosen and dissolve dirt as on machinery or circuit boards or in corners of a room, 100% undiluted water, distilled or deionized, may be employed. Additives such as detergents or disinfectants may be employed provided that they are stable at the operating temperatures of the system. The proportions of additives and water may be varied depending on the application. The solution may contain vaporizers, emulsifiers, degreasers, oxidants, alkalis, deodorizers, antiseptics, germicides, sterilants, corrosion inhibitors, or the like. In addition, the liquid may comprise humidifiers, fresheners, and other reagents which the user may wish to impart to the air or to a surface or object.

In accordance with the invention, in a preferred embodiment, reservoir 65 contains an aqueous solution of substantially 8% Hydrogen Peroxide (H₂O₂). Reservoir 65 may also contain a corrosion—inhibiting agent marketed in connection with the trademark ARMA-SOL®.

Particular applications of the system include cleaning, disinfection, sterilization, and decontamination of equipment, circuit boards and/or surfaces and spaces such as rooms in connection with maintenance or janitorial work. Wand 56 provides the capability for precise direction of the vapor flow even to small objectives and in particular allows impingement of the vapor into small, confined, or relatively inaccessible objects or spaces. Apparatus in accordance with the invention provides a general purpose cleaning capability with particular applicability to remote or relatively inaccessible areas, objects and small parts.

The invention may be employed in connection with burnishing or cleaning of small parts such as time-piece apparatus, in connection with metal plating, printing and photo-engraving, lapidary and stone cutting activity, manufacture and/or repair of electronic components, removal of such things as wallpaper, labels and the like, in connection with dry-cleaning, sanitizing and sterilizing of eating implements, in connection with optical and optometric laboratory and office work, with jewelry, dental and medical offices and operating theatres, miniature instrument manufacture and repair, and biological and analytic laboratories, among many other applications. Use of apparatus in accordance with the invention is particularly advantageous in that its flexibility permits cleaning of small parts to be accomplished with a minimum of disassembly.

A particularly useful application of the invention is in connection with the cleaning and maintenance of military equipment, including weapons and related items. This has become timely in view of the current concern with possibility of chemical or biological warfare attacks as well as emphasis on repair and maintenance as opposed to acquisition of new items.

System 10 preferably operates at substantially 1500 watts at 120 or 240 volts. When the power switch 18 is turned to the ON position, white signal light 20 and amber signal light 36 are illuminated. As indicated, illumination of light 22 indicates that power is being provided to the system and light 36 indicates that the heating cartridge 132 of the vapor generator 120 is drawing current. When vaporization chamber 124 reaches the desired temperature of 500° degrees. F., indicator light 136 goes out under the influence of electronic circuitry. This informs the operator that superheated steam or other superheated vapor is available.

As noted any one of switches 24, 38, 192 can be actuated to cause the issuance of superheated vapor from tube 62. When the machine “warms up”, a period of 6 minutes is normally sufficient for the chamber 126 to reach operating temperature for generation of superheated vapor.

As depicted in FIGS. 7, 8, and as fully disclosed in the '009 patent incorporated by reference herein, the invention may employ a plurality of vapor generator systems in order to adjust the frequency, duration and size—among other parameters—of flow of superheated vapor. The description of such multi-unit superheated vapor generators will be brief herein in view of the '009 patent.

As depicted in FIGS. 7, 8, a superheated vapor generator system 310 in accordance with the invention comprises a plurality, in the depicted embodiment four, of superheated vapor generators 312a, 312b, 312c, and 312d. Vapor generators 312a-312d are coupled to an output manifold collector assembly 314 by a conduit system 316.

Superheated vapor generators 312a-312d, and each of them, are in accordance with the superheated vapor generators described and claimed in U.S. Pat. No. 4,414,037 or U.S. Pat. No. 5,471,556 to the inventor herein, as is discussed in further detail hereinbelow. Manifold system conduit sections 318 connects the output of superheated vapor generator 312a to manifold 314; conduit section 320 connects vapor generator 312b to manifold 314; conduit section 322 connects vapor generator 312c to manifold 314, and conduit section 324 connects vapor generator 312d to manifold 314. Check valves 318′, 320′, 322′, and 324′, are positioned in conduit sections 318, 326, 322, and 324, respectively, to prevent backflow of superheated vapor generated from the superheated vapor generators 312a-312d.

Intake conduits 326, 328, 330, 332 connect generators 312a, 312b, 312c, 312d, respectively, to a source of liquid (not shown) for use in vaporization by the generators.

Connected to manifold 314 is an output conduit 334 for issuance of superheated vapor generated by vapor generators 312a-312d and collected in manifold 314. In particular applications, output 334 constitutes a hose, a pipe, and the like, or may constitute a nozzle connectable to a vapor controller of the type described and claimed in the '556 patent.

Referring to FIG. 8, depicted therein is a control system 336 for vapor generator systems in accordance with the invention. Controller 336 comprises a logic “smart box” of conventional type having an offperiod control switch 338 and an on period control switch 340. Controller 336 is electrically connected to vapor generators 312a, 312b, 312c, 312d, in parallel wiring. The setting of switch 338 determines the time interval during which each generator 312 is “off” per cycle and switch 340 determines the time interval which generators 312 are “on” as described in further detail in the '009 patent.

An indicator light (not shown) indicates in the same manner as shown in connection with FIGS. 1-5 that the power is on and is part of the system circuitry shown in the '009 patent.

In operation, timer controller 336 is set for: the desired intervals of operation (that is, pumping of liquid to the generator for vaporization providing superheated vapor output from the generator) for each generator 312a-312d; for the desired sequence of operation of the respective generators; and for the period of time between the activation of a particular generator in one cycle and its activation in the next cycle. This is accomplished by adjustment of switches 38, 40 as fully disclosed in the '009 patent.

A power switch 396 connected to a source of external power (not shown) is turned to the “on” position. At this point, the first generator in the selected sequence, 312a, is caused to produce superheated vapor by activation of a pump (not shown) supplying liquid to generator 312a in the same manner as shown in connection with FIGS. 1-5. In a typical cycle, generator 312a will produce output superheated steam for four (4) seconds and will be set to repeat this operation twelve (12) seconds after cessation of emission of steam or sixteen (16) seconds after commencement of output of steam.

In the 12 seconds of downtime for generator 312a, generators 312b, 312c, 312d are performing the identical operation described for generator 312a; concurrently for at least a part of its downtime, generator 312a is in a “recovery phase” in which its temperature, reduced by the heat loss from vaporization of water producing steam in its active phase, is raised once again to operating temperature, at which point generator 312a is ready to produce additional steam in the next cycle. Of course, this series of events is identical for each generator 312a-312d.

Superheated vapor produced by the invention is supplied to manifold collector 314 via output conduits 318,320,322,324 for generators 312a, 312b, 312c, 312d, respectively.

The amount of downtime, length of time on, pressure and volume of output vapor, are parameters of the system 310. For example, if additional steam per unit time is desired, the operating cycle may be shortened or additional generator units may be added; such addition of units may be in “parallel” with existing arrangement of generators to operate concurrently in the existing sequence, thereby maintaining timing of the existing cycle, or in series, whereby the cycle will be lengthened.

In the foregoing manner, generation of superheated vapor can be accomplished under precise control for numerous applications where a substantially continuous flow of output vapor is desired as, for example, in operation of a steam-powered engine or generator for cleaning, disinfection, sterilization and decontamination of large, multiple or difficult-access objects.

In operation the operator directs the tube 62 toward the object which is to receive superheated vapor, which issues from tube 62. The superheated vapor such as steam, is “dry” i.e. having a high proportion of gas as opposed to content of fluid droplets. This has a favorable effect in that the amount of liquid included in the vapor is so small that the residue does not interfere with further cleaning and does not require a cleanup, the amount of fluid residue being so small that it can normally be readily removed by a cloth or paper towel. In many instances, the liquid residue rapidly completely evaporates (either naturally due to the small amount of liquid in the superheated vapor in the first instance and the elevated temperature of the surface or induced by application of a drying flow)—without use of toweling. This is particularly advantageous in the treatment of avionics and electronics which are subject to corrosion from liquid water but cannot be readily dried with a towel.

In a particular application for cleaning, disinfection, sterilization and decontamination of sensitive avionics or electronics the end of tube 62 is initially positioned sufficiently closely to the surface/area to be treated such that the velocity, temperature and concentration of sterilant are higher in the impact region of the flow of superheated vapor. Thereafter, tube 62 is moved away from the treated surface such that velocity, temperature and concentration of sterilant are reduced. This may be performed in connection with inclusion of cooler air into the vapor flow which can be employed to assist in evaporation of condensed liquid form the treated surface as well as to cool said surface. Pooling of liquid is virtually eliminated. The material removed by a towel in the form of a residue is easily disposed of, particularly in cases where any removed contaminants are non-hazardous or non-toxic.

Performance testing has evidenced that with a substantially 8% aqueous solution of H₂O₂ cleaning of standard soiling (geobacilillus steamthermophilus spore contaminated dried blood) effectiveness of cleaning was 99.9% with use of superheated vapor for thirty (30) seconds.

With regard to disinfection, use of the invention with superheated steam, with or without a disinfectant, resulted in complete success with 60-second treatment time.

Concerning spore reduction it has been established, using Bactillus Subtlis at 60 seconds treatment time, that among other successful results; (1) average disinfection effectiveness with 8% aqueous solution of H₂O₂ was 99.9994% and for superheated steam alone was 99.9983%; and (2) H₂O₂ reduced the number of residual spores by a factor of three (3) compared to superheated steam alone.

With respect to sterilization, using spores of geobacillus steamthermophilus (spores used to test autoclaves and recommended for H₂O₂) two treatments with 8% H₂O₂ were successful in producing complete sterility. One treatment comprised a 60-second cleaning with H₂O₂, followed by sealing in a bag with H₂O₂, and boiling for 30 minutes. Further testing established that with 90-second exposure and an 8% aqueous solution of H₂O₂ plus ARMA-SOL®, complete sterility was achieved without risking corrosion.

Another test comprised a 180-second cleaning followed by bagging and leaving 12-14 hours with no further heating. This contrasts with existing methods where substantially higher concentrations of H₂O₂ are used. Other concentrations of H₂O₂ in other media may be employed in accordance with the invention.

In accordance with the invention, solutions may be employed including NH₃OH, oxygenated water, ozonified water, and peroxides including H₂O₂ (HOOH), alkyl hydrogen peroxide (R—OO—H), dialkyl hydrogen peroxide (R—O—O—R′), peroxy acids (RCO—O—O—H), peroxy esters (R—CO—OOR′) and diacyl peroxides (R—CO—O—O—CO—R′) where “R” and “R′” are defined as alkyl groups of the general formula C nH2 n+1 where n is from 1 to 50.

Concerning decontamination, the H₂O₂ functioning as an oxidant and hydrolyzing agent has the effect upon use in accordance with the invention of negating common contaminants through oxidation and hydrolysis. In a military context, this includes nerve gases, mustard gas and Lewisite. The hydrolyzing and oxidizing action of H₂O₂ is substantially enhanced due to the elevated temperature of the superheated vapor in which it is disseminated, in accordance with the invention.

By use of the invention, the operator gains the capability of precisely directing relatively dry vapor to the object targeted. The operator can control the amount of heat transferred to any target by varying the distance between the end of the tube 62 and the object of the heat, decreasing the distance and increasing the heat applied, increasing the distance and decreasing the heat applied. The invention produces a jet of superheated vapor of a temperature of approximately 300° degree. F. at the nozzle and for a short distance. It has been found that approximately 2-3 inches from the nozzle the vapor has cooled sufficiently that human flesh will not be burned by it.

Superheated vapor issues at approximately 190 PSI. As a result of this, the superheated vapor impinges upon, and into such relatively hard-to-reach spaces as portholes, crevices, and the like. Application of heat causes contaminants to soften, liquify, and generally decompose or disengage from the surfaces on which they are disposed. This applies to such normally hard-to-clean substances as grease, oil, grime, paste, glue, and carbon. A burst of superheated vapor, such as steam in a cleaning context, lasting 5-10 seconds, is sufficient for many cleaning purposes. In the preferred embodiment, the burst of superheated vapor produced by the system 10 will last approximately 15-30 seconds. For removal of tenacious contaminants, heat applied by the invention initiates cleaning. Then a cleaner or emulsifier may be applied in conventional fashion at which point a further burst of superheated vapor from the invention completes removal of the contaminant. For larger surfaces where a substantial and/or continuous vapor flow is required, this may be achieved by use of the multiple unit system disclosed in connection with FIG. 7, 8, herein and further disclosed in the '009 patent.

Actuation of one of the switches 24, 38, or 192 activates electric motor 86 which in turns drives pump 72. The configuration of the pump 72 and in particular the cam 82 is such as to inhibit vapor lock in the fluid line which might be caused by the heat in the system. In addition, the cam arrangement enables a more effective combating of back pressure of the vapor as it builds up within the generator 120. This allows steam to exit tube 62 in a burst with greater force at times even than the rated 120 PSI and for a longer vapor flow, with the back pressure under control.

As a result of the action of pump 72, liquid is drawn into the system 10 through conduit 40. The liquid proceeds through conduit 40 and into pipe 88. Check valve 90 inhibits any tendency to back flow. The liquid then passes through T-fitting 94 and through second check valve 100. The liquid then passes into the superheated vapor generator 120 and into chamber 126 and very rapidly vaporizes to form superheated vapor.

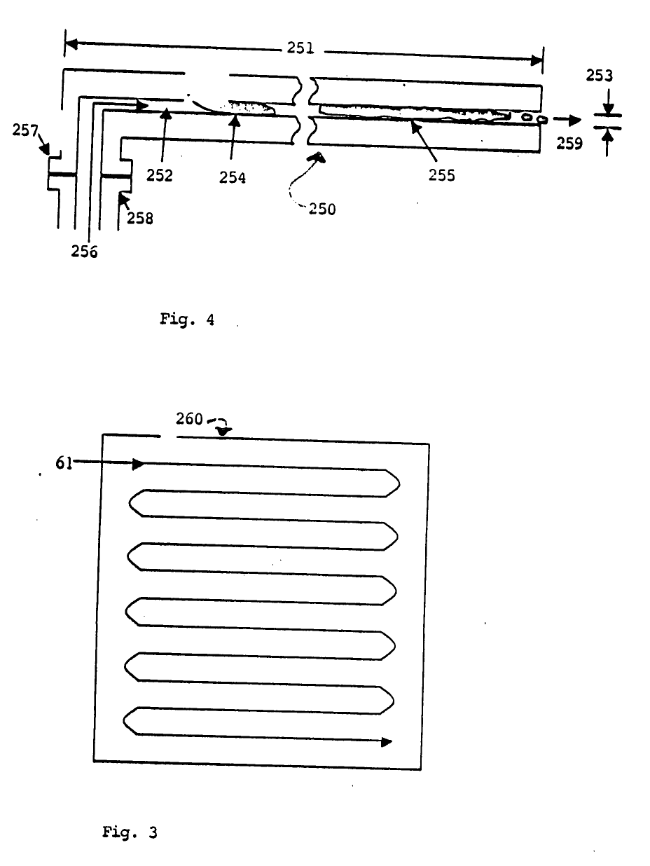

Turning to FIG. 4, an instrunent 250 is to be treated. The instrument 250 has a lumen 251, with a length 252, substantially longer than a diameter 253 and is filled with two contaminant plugs 254, 255. Superheated vapor 256 enters through a port 257 accessed by a nozzle 258 from which superheated vapor issues. The pressure of the superheated vapor penetrates and heats contaminant plugs 254, 255 thus causing particles of debris 259 to be blown off the end of contaminant plug 255. Contaminant plugs 254, 255 are soil which may be of various types and contain water which vaporizes and exerts pressure; they frequently also contain fats which liquefy and thus reduce adherence. Examples of such lumens would be endoscopes whose dimension 251 is 24 to 36 inches and dimension 253 is 2 to 5 mm and needles whose dimension 251 is 1-4 inches and dimension 253 is 0.2 to 0.7 mm. The port location and type can vary providing a substantially leakproof seal is obtained. Lumen 251 may be curved or straight.

As shown in FIG. 3, a method in accordance with the invention facilitates contact between superheated vapor jet and an item 260 to be cleaned, disinfected, sterilized or decontaminated. Item 260, is traversed with the jet of vapor in a serpentine pattern 261. This pattern can then be repeated as needed.

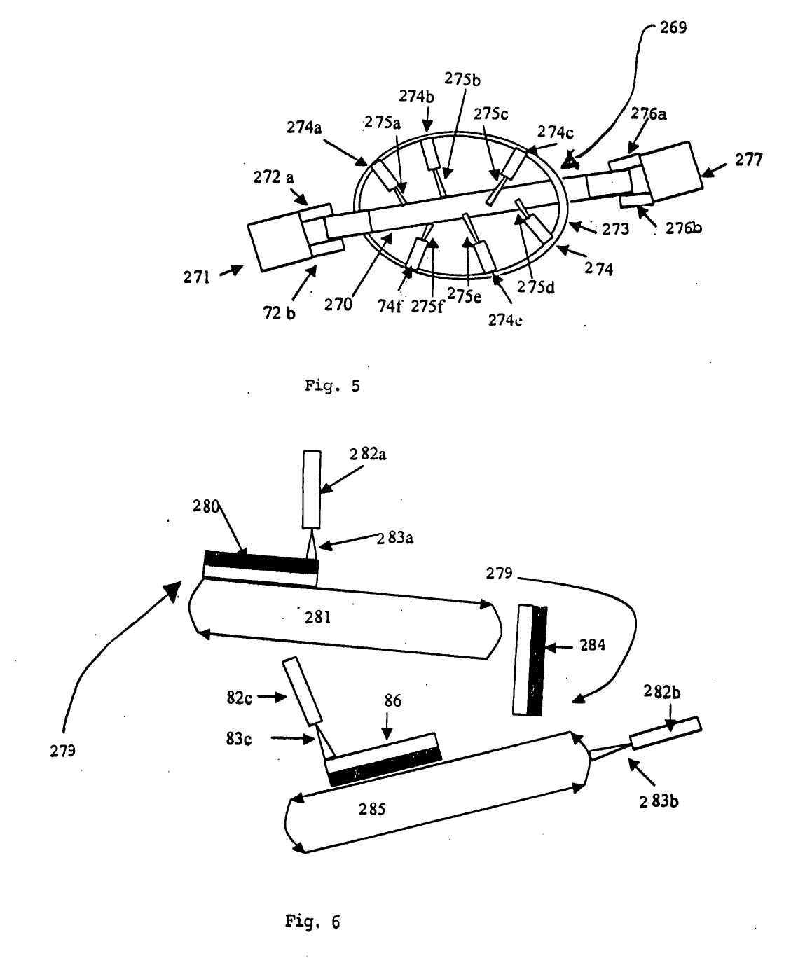

In accordance with a further aspect of the invention FIG. 5 shows a method of automating the treatment of an item 270 to be treated (i.e., cleaned/disinfected/sterilized/decontaminated). A detailed disclosure and discussion of the system depicted schematically herein is contained in co-pending provisional patent application Ser. No. 60/612,316 filed Sep. 22, 2004, hereby incorporated by reference herein. A system 269 includes, a manifold 273 of nozzles 274a-f, (depicted for specificity as six in number) producing a plurality (six in the depicted example) of jets 275a-f.

Item 270 is picked up by grippers 272a,b, attached to a robotic arm 271 and moved through the ring of jets 275a-f. The opposite end of item 270 is gripped by grippers 276a,b on a receiving robotic arm 277 at which point grippers 272a,b release and arm 271 picks up the next item to be treated. Arm 277 pulls item 270 through jets 275a-f, and places the item aside. The cycle may now be repeated. Pursuant to the invention it is feasible to program the robotic arm to undertake a variety of actions to improve the treatment of the item in various ways without departing from the invention. For example where a hinged device is to be treated the program may provide extra time for the hinged area or rotate the item to position it approximately. Such treatment programs are within the purview of one having normal skill in the art of robotics by following the above method. The selection of the treatment program to be run for a given item may be manual or automatic using an automatic recognition method, such as bar codes, radio frequency identity devices or machine vision systems and may be accomplished in various ways in accordance with the invention.

FIG. 6 depicts a cross sectional drawing of a system 279 and method to continuously treat items 280, 284, 286. System 279 includes mechanical conveyors 281, 285 and three nozzles, 282a, 282b, 282c. Nozzle 282a produces a jet 283a which cleans the top surface and sides of item 280. Item 284 is shown at the next step of the process where it flips as it transitions from the conveyor 281 to conveyor 285 which is treated by jet 283b from nozzle 282b to prevent recontamination of the previously treated side.

In a further step nozzle 282c produces a jet 283c which cleans the top surface and sides of item 286. In carrying out the invention it is possible to combine elements of the above figures in many ways without departing from the invention. Alternative methods of implementing the nozzles in this figure are a manifold of multiple jets similar to that shown in FIG. 5 or a programmed arm for moving the nozzles in a predetermined path. Further conveyors and additional nozzles may be employed to provide different vapors at each nozzle. While steam is the lowest cost vapor, other combinations of vapors can have specific uses. Ammonia can be used to neutralize acidic surfaces. Hydrogen peroxide and other organic peroxides, peroxy acids and peroxy esters are strong oxidizing agents and effective disinfectants.

Accordingly, an organic peryoxyacid step may be followed by an ammonia neutralization step followed by a clean and dry which kills substantially everything including small hidden bacteria spores. By extending the time of exposure to the jet the organisms are exposed to progressively high temperatures and any protective coatings of other organisms, bioslime and contaminants are removed.

As described hereinabove, there have been therefore been provided systems and methods for cleaning disinfection, sterilization and decontamination. Though a preferred embodiment has been described and depicted herein, the scope of the invention is defined by the appended claims to be filed pursuant to law, interpreted in light of the specification and drawings.

What is claimed is:

1. A system for performing cleansing comprising:
means for providing superheated vapor containing at least one cleansing agent therein for cleansing contact with at least one object or entity to be cleansed.

2. The invention as set forth in claim 1 in wherein said at least one cleansing agent comprises vaporized aqueous solution of Hydrogen Peroxide (H₂O₂).

3. The invention as set forth in claim 2 wherein concentration of (H₂O₂) is substantially equal to eight percent (8%).

4. The invention as set forth in claim 1 wherein said at least one cleansing agent comprises Ammonium Hydroxide (NH₃OH).

5. The invention as set forth in claim 4 wherein concentration of Ammonium Hydroxide (NH₃OH) is substantially equal to eight percent (8%).

6. The invention as set forth in claim 1 wherein said at least one cleansing agent comprises oxygenated water.

7. The invention as set forth in claim 6 wherein concentration of said oxygenated water is such that it is substantially non-corrosive.

8. The invention as set forth in claim 1 wherein said at least one cleansing agent comprises ozonified water.

9. The invention as set forth in claim 8 wherein concentration of said ozonified water is such that it is substantially non-corrosive.

10. The invention as set forth in claim 1 wherein said at least one cleansing agent comprises at least one of the group alkyl hydrogen peroxide (R-00-H) where “R” is any one of an alkyl group of the general formula CₙH₂ₙ₊₁ wherein 1≦n≦50.

11. The invention as set forth in claim 10 wherein concentration of said at least one cleansing agent is such that it is substantially non-corrosive.

12. The invention as set forth in claim 1 wherein said at least one cleansing agent comprises at least one of the group dialkyl hydrogen peroxide (R-00-R′) where “R” and “R′” are any one of alkyl groups of the general formula CₙH₂ₙ₊₁ wherein 1≦n≦50.

13. The invention as set forth in claim 12 wherein concentration of said cleansing agent is such that it is substantially non-corrosive.

14. The invention as set forth in claim 1 wherein said at least one cleansing agent comprises at least one of the group peroxy esters (R—CO-00-R′) where “R” and “R′” are any one of the group of the general formula CₙH₂ₙ₊₁ wherein 1≦n≦50.

15. The invention as set forth in claim 14 wherein concentration of said at least one cleansing agent is such that is substantially non-corrosive.

16. The invention as set forth in claim 1 wherein said at least one cleansing agent comprises at least one of the group of diacyl peroxides (R—CO—O—O—CO—R′) where “R” and “R′” are any one of the group of the general formula CₙH₂ₙ₊₁ wherein 1≦n≦50.

17. The invention as set forth in claim 16 wherein concentration of said at least one cleansing agent is such that it is substantially non-corrosive.

18. The invention as set forth in claim 1 wherein said means for providing superheated vapor containing at least one cleansing agent therein includes exposure control means for controlling exposure of at least one object or entity to be cleansed to said superheated vapor containing at least one cleansing agent.

19. The invention as set forth in claim 18 wherein said exposure control means includes means for controlling generation of said superheated vapor containing at least one cleansing agent.

20. The invention as set forth in claim 19 wherein said exposure control means comprises means for controlling duration of generation of said superheated vapor containing at least one cleansing agent.

21. The invention as set forth in claim 18 wherein said exposure control means is operable to expose said at least one object or entity to said superheated vapor containing at least one cleansing agent for a duration substantially equal to thirty (30) seconds, whereby said object or entity is substantially cleaned.

22. The invention as set forth in claim 21 wherein said at least one cleansing agent comprises aqueous solution of Hydrogen Peroxide (H₂O₂).

23. The invention as set forth in claim 22 wherein said concentration of Hydrogen Peroxide (H₂O₂) is substantially equal to eight percent (8%).

24. The invention as set forth in claim 20 wherein said exposure control means is operable to expose said at least one object or entity to said superheated vapor containing at least one cleansing agent for a duration substantially equal to sixty (60) seconds whereby said object or entity is substantially disinfected.

25. The invention as set forth in claim 20 wherein said exposure control means is operable to expose said at least one object or entity to said superheated vapor containing at least one cleansing agent such that said object or entity is substantially cleaned.

26. The invention as set forth in claim 20 wherein said exposure control means is operable to expose said at least one object or entity to said superheated vapor containing at least one cleansing agent such that said at least one object or entity is substantially disinfected.

27. The invention as set forth in claim 20 wherein said exposure control means is operable to expose said at least one object or entity to said superheated vapor containing at least one cleansing agent such that said object or entity is substantially decontaminated.

28. The invention as set forth in claim 20 wherein said exposure control means is operable to expose said at least one object or entity to said superheated vapor containing at least one cleansing agent such that said object or entity is substantially sterilized.

29. The invention as set forth in claim 20 wherein said exposure control means is operable to expose said at least one object or entity to said superheated vapor containing at least one cleansing agent such that said object or entity is substantially decontaminated.

30. The invention as set forth in claim 20 where said exposure control means is operable to expose said at least one object or entity to said superheated vapor containing at least one cleansing agent for a duration substantially equal to ninety (90) seconds whereby said at least one object or entity is substantially sterilized.

31. The invention as set forth in claim 21 where in said exposure control means is operable to expose said at least one object or entity to said superheated vapor containing at least one cleansing agent for a duration in excess of ninety (90) seconds whereby said object or entity is substantially decontaminated.

32. The invention as set forth in claim 18 wherein said exposure control means comprises means for controlling position and orientation of said at least one object or entity with respect to source of said superheated vapor containing at least one cleansing agent.

33. The invention as set forth in claim 32 wherein said exposure control means comprises means connectable to said means for providing superheated vapor containing at least one cleansing agent and for directing said superheated vapor containing at least one cleansing agent.

34. The invention as set forth in claim 33 wherein said directing means comprises at least one tube for passage therethrough of said superheated vapor containing at least one cleansing agent.

35. The invention as set forth in claim 18 wherein said exposure control means comprises means for controlling continuity of generation of said superheated vapor containing at least one cleansing agent.

36. The invention as set forth in claim 1 further including means for controlling input of liquid to said means for providing superheated vapor containing at least one cleansing agent therein.

37. The invention as set forth in claim 1 further including means for supplying liquid to said means for providing superheated vapor containing at least one cleansing agent therein.

38. The invention as set forth in claim 1 wherein said means for providing superheated vapor containing at least one cleansing agent therein comprises at least one flash boiler.

39. The invention as set forth in claim 32 wherein said means for controlling position and orientation of said object or entity with respect to source of said superheated vapor containing at least one cleansing agent is substantially fully automated.

40. The invention as set forth in claim 39 wherein said means for controlling position and orientation of said object or entity with respect to source of said superheated vapor containing at least one cleansing agent is connectable to at least one robotic arm.

41. A method for cleansing comprising:
providing superheated vapor containing at least one cleansing agent therein for cleansing contact with at least one object or entity to be cleansed.

42. The method as set forth in claim 41 wherein said at least one cleansing agent comprises vaporized solution of Hydrogen Peroxide (H₂O₂).

43. The method as set forth in claim 42 wherein concentration of Hydrogen Peroxide (H₂O₂) is substantially equal to eight percent (8%).

44. The method as set forth in claim 41 wherein said at least one cleansing agent comprises Ammonium Hydroxide (NH₃OH).

45. The method as set forth in claim 44 wherein concentration of Ammonium Hydroxide (NH₃0H) is substantially equal to eight percent (8%).

46. The method as set forth in claim 41 wherein said at least one cleansing agent comprises oxygenated water.

47. The method as set forth in claim 46 wherein concentration of said oxygenated water is such that it is substantially non-corrosive.

48. the method as set forth in claim 41 wherein said at least one cleansing agent comprises ozonified water.

49. The method as set forth in claim 48 wherein concentration of said ozonified water is such that it is substantially non-corrosive.

50. The method as set forth in claim 41 wherein said at least one cleansing agent comprises at least one of the group alkyl hydrogen peroxide (R-00-H) where “R” is any one of an alkyl group of the general formula CₙH₂ₙ₊₁ wherein 1≦n≦50.

51. The method as set forth in claim 50 wherein concentration of said at least one cleansing agent is such that it is substantially non-corrosive.

52. The method as set forth in claim 41 wherein said at least one cleansing agent comprises at least one of the group dialkyl hydrogen peroxide (R-00-R′) where “R” and “R′” are any one of alkyl groups of the general formula CₙH₂ₙ₊₁ wherein 1≦n≦50.

53. The method as set forth in claim 52 wherein concentration of said cleansing agent is such that it is substantially non-corrosive.

54. The method as set forth in claim 41 wherein said at least one cleansing agent comprises at least one of the group peroxy esters (R—CO-00-R′) where “R” and “R′” are any one of the groups of the general formula CₙH₂ₙ₊₁ wherein 1≦n≦50.

55. The method as set forth in claim 54 wherein concentration of said at least one cleansing agent is such that it is substantially non-corrosive.

56. The method as set forth in claim 41 wherein said at least one cleansing agent comprises at least one of the group of diacyl peroxides (R—CO—O—O—CO—R′) where “R” and “R′” are any one of the group of the general formula CₙH₂ₙ₊₁ wherein 1≦n≦50.

57. The method as set forth in claim 56 wherein concentration of said at least one cleansing agent is such that it is substantially non-corrosive.

58. The method as set forth in claim 41 including the step of controlling exposure of said and least one object or entity to said superheated vapor containing at least one cleansing agent.

59. the method as set forth in claim 58 wherein said step of controlling exposure includes control of generation of said superheated vapor containing at least one cleansing agent.

60. The method as set forth in claim 59 wherein said step of controlling exposure comprises controlling duration of generation of said superheated vapor containing at least one cleansing agent.

61. The method as set forth in claim 58 wherein said step of exposure control exposes said at least one object or entity to said superheated vapor containing at least one cleansing agent for a duration substantially equal to thirty (30) seconds whereby said object or entity is substantially cleaned.

62. The method as set forth in claim 61 wherein said at least one cleansing agent comprises aqueous solution of Hydrogen Peroxide (H₂O₂).

63. The method as set forth in claim 62 wherein said concentration of Hydrogen Peroxide (H₂O₂) is substantially equal to eight percent (8%).

64. The method as set forth in claim 60 wherein said at least one object or entity is exposed to said superheated vapor containing at least one cleansing agent for a duration substantially equal to sixty (60) seconds whereby said object or entity is substantially disinfected.

65. The method as set forth in claim 60 wherein said at least one object or entity is exposed to said superheated vapor containing at least one cleansing agent such that said at least one object or entity is substantially cleaned.

66. The method as set forth in claim 26 wherein said at least one object or entity is exposed to said superheated vapor containing at least one cleansing agent such that said at least one object or entity is substantially disinfected.

67. The method as set forth in claim 60 wherein said at least one object or entity is exposed to said superheated vapor containing at least one cleansing agent such that said object or entity is substantially decontaminated.

68. the method as set forth in claim 60 wherein said at least one object or entity is exposed to said superheated vapor containing at least one cleansing agent such that said at least one object or entity is substantially sterilized.

69. The method as set forth in claim 60 wherein said at least one object or entity is exposed to said superheated vapor containing at least one cleansing agent such that said at least one object or entity is substantially decontaminated.

70. The method as set forth in claim 60 wherein said at least one object or entity is exposed to said superheated vapor containing at one cleansing agent for a duration substantially equal to ninety (90) seconds whereby said object or entity is substantially sterilized.

71. The method as set forth in claim 61 wherein said at least one object or entity is exposed to said superheated vapor containing at least one cleansing agent for a duration in excess of ninety (90) seconds whereby said object or entity is substantially decontaminated.

72. The method as set forth in claim 58 wherein said at least one object or entity is exposed to said superheated vapor containing at least one cleansing agent by means of controlling position and orientation of said at least one object or entity with respect to source of said superheated vapor containing at least one cleansing agent.

73. The method as set forth in claim 72 wherein said at least one object or entity is exposed to said superheated vapor containing at least one cleansing agent through direction of said superheated vapor containing at least one cleansing agent to at least one selected portion of said at least one object or entity.

74. The method as set forth in claim 73 wherein said directing of said superheated vapor containing at least one cleansing agent is accomplished by at least one tube.

75. The method as set forth in claim 58 wherein continuity of exposure of said at least one object or entity to said superheated vapor containing at least one cleansing agent is controlled.

76. The method as set forth in claim 41 further including the step of controlling input of liquid for controlling output of said superheated vapor containing at least one cleansing agent.

77. The method as set forth in claim 41 further including the step of providing means for supplying liquid for input to provide output of superheated vapor containing at least one cleansing agent.

78. The method as set forth in claim 41 wherein said superheated vapor containing at least one cleansing agent is at least partially generated by at least one flash boiler.

79. The method as set forth in claim 72 wherein said control of position and presentation of said object or entity is substantially fully automated.

80. The method as set forth in claim 79 wherein at least one robotic arm is employed to control position and orientation of said at least one object or entity.

81. A system for performing cleansing comprising: means for providing superheated vapor for cleansing contact with at least one object or entity to be cleansed, said superheated vapor containing at least one cleansing agent and at least one anti-corrosive agent.

82. The invention as set forth in claim 81 wherein said at least one anti-corrosive agent comprises a solution marketed under the trademark ARMA-SOL®.

83. The invention as set forth in claim 81 further including exposure control means for controlling exposure of said at least one object or entity to said superheated vapor containing at least one cleansing agent.

84. The invention as set forth in claim 83 where said exposure control means controls duration of exposure of said object or entity to said superheated vapor.

85. The invention as set forth in claim 83 wherein said exposure control means controls which portion of said at least one object or entity is exposed to said superheated vapor.

86. The invention as set forth in claim 85 wherein said exposure control means comprises: means for moving said at least one object or entity in a path such as to expose substantially all of said object or entity to said superheated vapor.

87. The invention as set forth in claim 86 wherein said path is at least partially tortuous.

88. A method for performing cleansing comprising:
providing superheated vapor for cleansing contact with an object or entity to be cleansed, said superheated vapor containing at least one cleansing agent and at least one anti-corrosive agent.

89. The method as set forth in claim 88 wherein said at least one anti-corrosive agent comprises a solution marketed under the trademark ARMA-SOL®.

90. The method as set forth in claim 88 further including exposure control of said at least one object or entity with respect to said superheated vapor.

91. The invention as set forth in claim 90 wherein said exposure control comprises control of duration of exposure of said object or entity to said superheated vapor.

92. The method as set forth in claim 90 wherein said exposure control comprises control of which portion of said at least one object or entity is exposed to said superheated vapor.

93. The method as set forth in claim 92 wherein said exposure control comprises moving said at least one object or entity in a path such as to expose substantially all portions of said object or entity to said superheated vapor.

94. The method as set forth in claim 93 wherein said path is at least partially tortuous.
